(19) United States
(12) Patent Application Publication
(10) Pub. No.: US 2008/0193671 A1
(43) Pub. Date: Aug. 14, 2008

(54) Process for the production of printing forms

(75) Inventors: Peer Dilling, Friedberg (DE); Josef Gottling, Friedberg (DE)

Correspondence Address: COHEN, PONTANI, LIEBERMAN & PAVANE LLP, 551 FIFTH AVENUE, SUITE 1210, NEW YORK, NY, 10176, US

(73) Assignee: MAN Roland Druckmaschinen AG, Offenbach am Main (DE)

(21) Appl. No.: 12/070,073

(22) Filed: Feb. 14, 2008

(30) Foreign Application Priority Data
Feb. 14, 2007 (DE) 10 2007 007 183.5

(51) Int. Cl. B05D 3/04; B05D 3/00; B05D 1/00; B32B 38/16

(52) U.S. Cl. 427/534; 427/264; 427/555; 427/596; 156/281; 156/273.3; 427/256

(57) ABSTRACT

A process for the production of a printing form, especially within a printing press, where a permanent and erasable image is provided on the rewritable surface of a printing form by means of the following steps: (a) the preparation of a printing form with a rewritable surface; (b) the all-over application of a rubber coating to the rewritable surface of the printing form; (c) the image data-oriented removal of the previously applied rubber coating; (d) the image data-oriented application of an imaging polymer to the surface in the areas from which the rubber coating was previously removed; and (e) the all-over fixation of the imaged surface.

### BACKGROUND OF THE INVENTION

1. Field of the Invention

The invention pertains to a process for the production of printing forms, wherein an imaging polymer is applied over selected areas of a rewritable surface.

2. Description of the Related Art

When printing is carried out with a printing form, a distinction is made in principle between processes which work with a printing form which can be written only once and those which work with a printing form which can be rewritten. Printing processes which use rewritable printing forms are also referred to in general by the phrase “computer to press/direct imaging”. The present invention pertains to a process for the production of a permanent and erasable image on this type of rewritable printing form.

Under the product name “DICOweb”, MAN Roland Druckmaschinen AG markets digital printing presses, which work with rewritable and erasable printing forms. In the production of these types of printing forms, a printing form cylinder is preferably subjected to an erasing step and to an imaging step. Imaging of the printing form is possibly followed by fixing and conditioning of the imaged printing form. The basic principles of the DICOweb technology are known from Helmut Kipphan: Handbuch der Printmedien [Printing Media Manual], Springer-Verlag, 2000, pp. 674-680.

### SUMMARY OF THE INVENTION

The process for the production of a rewritable and erasable printing form known from the prior art, which comprises the steps of erasing, imaging, fixation, and conditioning, is to be improved with respect to efficiency and quality by means of novel process alternatives.

Taking this as its starting point, the production of printing forms according to the present invention includes at least the following steps:

(a) preparing a printing form with a rewritable surface;

(b) applying a rubber coating to the entire rewritable surface of the printing form;

(c) removing image data-oriented surface areas of the previously applied rubber coating;

(d) applying an imaging polymer to the image-data oriented surface areas from which the rubber coating was previously removed; and

(e) fixing the imaging polymer on the image-data oriented surface areas.

According to a second aspect of the invention, the process includes at least the following steps:

(a) preparing a printing form with a rewritable surface;

(b) applying an adhesion primer to the rewritable surface of the printing form; and

(c) applying an imaging polymer to the image data-oriented areas of the surface, namely, to the adhesion primer.

According to a third aspect of the invention, the process includes at least the following steps:

(a) preparing a printing form with a rewritable surface;

(b) heating image data-oriented areas of the rewritable surface; and

(c) applying an imaging polymer to the surface in the image data-oriented areas where the surface had previously been heated.

All three process alternatives of the present invention improve the efficiency and quality with which rewritable and erasable printing forms can be produced.

The process alternative according to the first aspect of the present invention represents a completely new process chain for the production of a rewritable printing form, which combines all-over process steps and image data-oriented process steps in optimal fashion.

The process alternatives according to the second and third aspects of the present invention causally improves the bonding of the imaging polymer to the surface of the rewritable printing form to be imaged.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIGS. 1A-1E are schematic diagrams of the steps of the process for the production of a printing form according to the first aspect of the invention; and

FIGS. 2A-2C are schematic diagrams of the steps of the process for the production of a printing form according to a second aspect of the invention.

### DETAILED DESCRIPTION OF THE PRESENTLY PREFERRED EMBODIMENTS

The present invention pertains to a process for the production of a printing form, namely, for the production of a permanent and erasable image on the surface of a rewritable and erasable printing form, where the process is preferably carried out within a printing press.

For the production of this type of printing form, a printing form or the base cylinder of a printing form is prepared with a rewritable and erasable surface, especially a metallic surface.

The surface of the printing form is first preferably erased and cleaned. The erasing and the cleaning of the surface are accomplished mechanically or chemically or physically or by a combination of these different principles. In particular, the image to be erased and other contaminants can be reliably removed from the surface by an atmospheric plasma, the atmospheric plasma being allowed to act on the surface to be cleaned at a relatively high power density. A plasma treatment of the surface of the printing form to be imaged improves the bonding of the imaging material to the surface of the printing form.

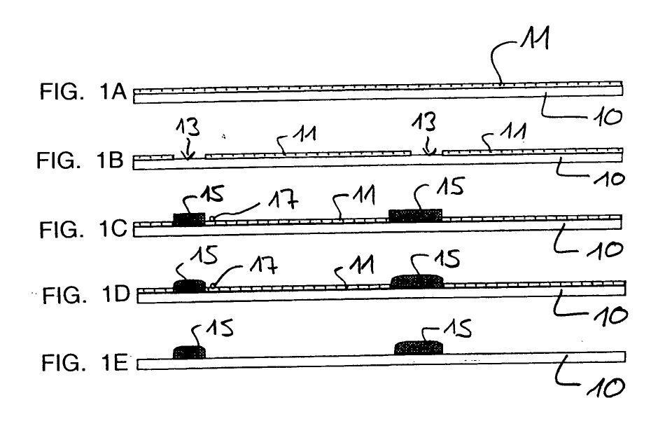

According to a first aspect of the present invention, which is described below with reference to FIGS. 1A-1E, the image is created on the printing form in the area of its rewritable surface 10 in such a way that, to create the image, an all-over rubber coating 11 is first applied to the rewritable surface 10. By providing an all-over rubber coating on the rewritable surface 10, a rubber coating is made available which has a thickness in the range between 1 μm and 10 μm. FIGS. 1A shows the intermediate result obtained on the printing form after the all-over rubber coating has been applied to the rewritable surface.

After the all-over application of the rubber coating 11 to the surface 10 of the printing form, the previously applied rubber coating 11 is removed from the surface 10 on the basis of the image data, so that there are now areas 13 on the surface 10 without a rubber coating 11. FIG. 1B shows the image data-oriented removal of the rubber coating 11 from the surface 10 of the printing form.

Then an imaging polymer 15 is applied in an image data-oriented manner to the surface 10 of the printing form to be imaged, namely, to the areas 13 from which the rubber coating 11 had been previously removed in an image data-oriented manner. FIG. 1C shows the intermediate result obtained after the image data-oriented application of the imaging polymer 15.

During the image data-oriented application of the imaging polymer 15 to the surface 10 of the printing form as shown in FIG. 1, undesirable artifacts 17 can form, which are deposited on the remaining areas of rubber coating 11 as indicated in FIG. 1.

After the image data-oriented imaging polymer 15 has been applied, the entire imaged surface is fixed; that is, the imaged surface is heated by induction, for example, to burn in and to dry the imaging polymer 15. FIG. 1D shows the intermediate result obtained after this all-over fixation.

The printing form according to FIG. 1D, the surface of which has been subjected to all-over fixation, is now used for printing, where, during the so-called “hard proof” stage, the remaining rubber coating 11 is separated from the surface 10 of the printing form, so that there are both ink-bearing surface areas carrying the image produced by the imaging polymer 15 and also water-bearing surface areas not carrying an image produced by the imaging polymer on the surface 10. FIG. 1E shows the printing form present after the hard proof, i.e., after the remaining rubber coating 11 has been removed during the hard proof stage.

When the rubber coating 11 is separated from the surface 10 of the imaged printing form during the course of the hard proof, not only the rubber coating 11 but also possible artifacts 17, which negatively impair the print quality, are separated together with the rubber coating 11 from the surface 10 of the printing form.

According to the first aspect of the present invention according to FIGS. 1A-1E, therefore, data image-oriented process steps are combined in optimal fashion with steps which cover the entire surface, thus guaranteeing high quality image production on an erasable and therefore rewritable printing form.

First, an all-over rubber coating is applied, and then the rubber coating is removed from the surface in an image data-oriented manner. After that, imaging polymer is applied to the surface in an image data-oriented manner, namely, to those areas from which the rubber coating has previously been removed. After the imaging polymer has been applied in an image data-oriented manner, the imaged surface is subjected to all-over fixation.

It should be pointed out that the image data-oriented removal of the rubber coating and the following image data-oriented application of the imaging polymer are preferably conducted with the use of one and the same laser. Application of an imaging polymer using a laser and a transfer foil is described in U.S. Pat. No. 5,601,022.

The rubber coating which is applied to the surface of the printing form and which covers the sections of the surface of the printing form on which no image is to be created during the imaging and fixation steps, prevents the oxidation of the sections of the surface of the printing form on which no image is to be produced, which means that the conditioning step necessary according to the prior art can be eliminated. In addition, the rubber coating guarantees that any artifacts which may have formed during the imaging process can be easily removed from the surface of the printing form.

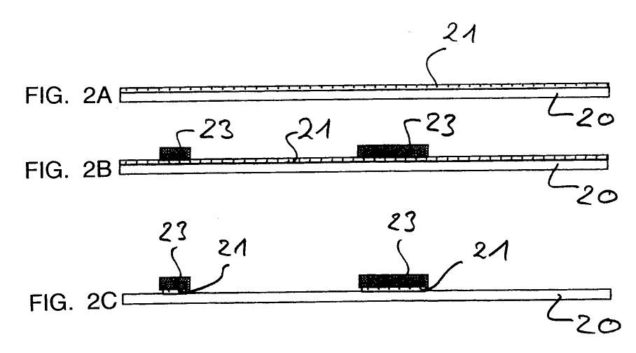

An alternative sequence of steps for producing an image on a printing form according to a second aspect of the present invention is described below on the basis of FIGS. 2A-2C. It is possible that the printing form has been erased and cleaned first. Thus, FIG. 2A shows the surface 20 of a printing form to be imaged, where an adhesion primer 21 is applied to the surface of the printing form to be imaged. As shown in FIG. 2A, the adhesion primer 21 is applied over the entire surface 20 of the printing form; alternatively, however, it is also possible to apply the adhesion primer to the surface 20 in an image data-oriented manner. The adhesion primer 21 is a water-soluble adhesion primer. FIG. 2A shows the intermediate result obtained after the application of the adhesion primer 21 to the surface 20 of the printing form to be imaged.

After the adhesion primer 21 has been applied in either an all-over manner or in an image data-oriented manner to the surface 20 of the printing form to be imaged, an imaging polymer 23 is applied to the surface in an image data-oriented manner, namely to previously applied adhesion primer 21. FIG. 2B shows the intermediate result obtained after the image data-oriented application of the imaging polymer 23 to the adhesion primer 21.

The imaged printing form according to the intermediate result of FIG. 2B is now used for printing, where, during the prewetting of the printing form or during the hard proof, the water-soluble adhesion primer 21 is removed from the sections of the surface 20 of the printing form to which no imaging polymer 23 was applied. FIG. 2C shows a printing form from which excess adhesion primer 21 has been removed during the prewetting or hard proof.

In the process for the production of a printing form visualized in FIG. 2C, bonding weaknesses of the imaging polymer to the surface 20 of the printing form to be imaged are causally improved, so that there is no need to subject the printing form to all-over fixation.

In the case of the process variant according to FIGS. 2A-2C, it also possible to eliminate the conditioning required according to prior art.

According to a third aspect of the present invention, a procedure is used to produce a rewritable and erasable printing form according to which a surface, possibly cleaned beforehand by the use of an atmospheric plasma, is heated in an image data-oriented manner before the imaging polymer is applied in an image data-oriented manner. That is, the surface is heated in the areas where the imaging polymer is to be applied.

The image data-oriented heating of the surface of the printing form to be imaged in the areas in which, afterwards, the imaging polymer is to be applied is preferably accomplished in such a way that, in the heated sections, the surface has a temperature of, for example, between 130° C. and 170° C., and preferably a temperature of approximately 150° C.

Imaging polymer can be applied with great precision to these heated areas of the surface to be imaged. In addition, the image data-oriented heating of the surface of the printing form promotes the melting of the imaging material. In addition, the image data-oriented heating of the rewritable surface of the printing form to be imaged causally improves the bonding of the imaging polymer to the surface to be imaged, so that there is no need for an all-over fixation or conditioning of the printing form.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A process for production of a printing form within a printing press, wherein a permanent and erasable image is provided on the rewritable surface of a printing form by means of the following steps:
preparing the rewritable surface of a printing form by at least one of erasing and cleaning the surface;
applying a rubber coating over all of the rewritable surface;
removing image-data oriented surface areas of the rubber coating;
applying an imaging polymer to the image-data oriented surface areas from which the rubber coating has been removed; and
fixing the imaging polymer on the image-data oriented surface areas.

2. The process of claim 1 wherein the preparing comprises subjecting the rewritable surface to an overall cleaning using an atmospheric plasma.

3. The process of claim 1 wherein the removing is carried out using a laser.

4. The process of claim 3 wherein the applying is carried out using the laser.

5. The process of claim 1 wherein the rubber coating is applied to a thickness between 1 μm and 10 μm.

6. A process for production of a printing form within a printing press, wherein a permanent and erasable image is provided on the rewritable surface of a printing form by means of the following steps:
preparing the rewritable surface of a printing form by at least one of erasing and cleaning the surface;
applying an adhesion primer over the rewritable surface; and
applying an imaging polymer to image-data oriented surface areas of the adhesion primer.

7. The process of claim 6 wherein the preparing comprises subjecting the rewritable surface to an overall cleaning using an atmospheric plasma.

8. The process of claim 6 wherein the adhesion primer is applied to image-data oriented surface areas of the rewritable surface.

9. The process of claim 6 wherein the adhesion primer is applied to all of the rewritable surface.

10. A process for production of a printing form within a printing press, wherein a permanent and erasable image is provided on the rewritable surface of a printing form by means of the following steps:
preparing the rewritable surface of a printing form by at least one of erasing and cleaning the surface;
heating image-data oriented surface areas of the rewritable surface; and
applying an imaging polymer to the image-data oriented surface areas which have been heated.

11. The process of claim 10 wherein the preparing comprises subjecting the rewritable surface to an overall cleaning using an atmospheric plasma.

12. The process of claim 10 wherein the heating comprises heating the image-data oriented surface areas to a temperature between 130° C. and 170° C.

13. The process of claim 12 wherein the image data oriented surface areas are heated to a temperature of approximately 150° C.
